(19) United States
(12) Patent Application Publication
(10) Pub. No.: US 2015/0235393 A1
(43) Pub. Date: Aug. 20, 2015

(54) IMAGE DEVICE AND DATA PROCESSING SYSTEM

(71) Applicant: VP ASSETS LIMITED, Shatin N.T. Hong Kong (CN)

(72) Inventors: Hon Wah WONG, Hong Kong (CN); Gia Chuong PHAN, Hong Kong (CN)

(73) Assignee: VP ASSETS LIMITED, Shatin N.T. Hong Kong (CN)

(21) Appl. No.: 14/703,615

(22) Filed: May 4, 2015

Related U.S. Application Data
(63) Continuation of application No. 12/273,341, filed on Nov. 18, 2008, now abandoned.

(51) Int. Cl. G06T 11/20; G06T 11/00

(52) U.S. Cl. CPC G06T 11/203; G06T 11/001

(57) ABSTRACT

A data processing system that in order to process subpixel rendered RGB data such as Clear Type™ font data to be processed and put correctly on a non-RGB stripe image device such as a 2×2 matrix RGBW quad pixel image device, a matching 2×2 quad pixel image device is selected to cope with the corresponding input data triplet from the subpixel rendered RGB input data string. Since the blue dot carries the least luminance information in a white balance, Green/Blue/Red (GBR) triplet from the subpixel rendered input RGB data string is selected to match with a 2×2 matrix quadpixel image device where G and R dots of the 2×2 quad pixel have the maximum overlapping area with the corresponding G and R dots from the GBR stripe pixel data.

### CROSS-REFERENCE TO RELATED APPLICATIONS

The present application is a Continuation Application under 35 USC 120 of U.S. patent application Ser. No. 12/273,341 filed on Nov. 18, 2008, the entire contents of which are hereby incorporated by reference.

### BACKGROUND OF THE INVENTION

1. Field of the Invention

The invention relates to an image device and a data processing system.

2. Description of the Related Art

Referring to FIG. 1, it shows conventional RGB True Type™ data on RGB display. Text is conventionally rendered by the embedded font rendering engine in the operating system, the font rendering engine usually assumes that the target display is arranged in the order of Red, Green, Blue (RGB) vertical stripes and the font engine optimizes the visual quality of the text on such display. True Type™ text is represented on RGB display by mapping text form to full RGB pixels. There is no presentation different for True Type™ font on a RGB or BGR vertical stripe display. The disadvantage of True Type™ font lays on presenting curve and obliges lines where zigzag dents are apparent.

Referring to FIG. 2, it shows conventional RGB Clear Type™ data on RGB display. New text rendering engine such as the Clear Type™ font proposed by Microsoft further enhances the apparent resolution of text by using subpixels to display text characters. The advantage of Clear Type™ font is that curve and oblige lines of the text characters are smoother than True Type™ text as shown in FIG. 1. However, when the display is not arranged in the order of RGB vertical stripes such as BGR vertical stripe type or 2×2 matrix RGBW quad pixel display, the RGB rendered Clear Type™ text looks worse on a BGR display or a 2×2 matrix RGBW display as shown in FIG. 3. Therefore mapping Clear Type™ font correctly in a matching display is the key to get best performance in text quality. Since Microsoft Clear Type™ font engine is designed only for stripe display, a new mapping method or system and in particularly a new Clear Type™ font mapping method or system needs to be created in order to meet the subpixel rendered text quality on non-stripe multi-color displays. [Note: True Type™ and Clear Type™ are trademark of Microsoft Corporation].

U.S. Pat. No. 6,239,783 and U.S. Pat. No. 6,219,025 map samples of the image data to individual pixel sub-samples, including mapping two or more samples to at least one of the pixel sub-component.

U.S. Pat. No. 6,282,327 adjusts the width of the character to create a non-uniformity of gaps between characters. Non-uniformity in the weight of character lines may be minimized by adjusting the black body width of each character.

U.S. Pat. No. 6,225,973 exploits the separately-controllable nature of individual RGB pixel sub-components to effectively increase a screen's resolution in the dimension perpendicular to the dimension in which the screen is striped.

U.S. Pat. No. 6,234,070 reduces color artifacts by comparing the different between the luminous intensity value, performing a gray scaling operation on pixels having an overall luminance that is less than the luminance associated with a background color and adjusting the luminous intensity values if a pixel has a color that falls outside a selected range of acceptable mixes of the foreground and background colors.

U.S. Pat. No. 6,624,828 improves the perceived quality of displayed images involves the use of information relating to a specific user's ability to perceive image characteristics such as color.

U.S. Pat. No. 6,421,054 and U.S. Pat. No. 6,307,566 take advantage of the ability to control individual RGB pixel sub-elements to effectively increase a screen's resolution in the dimension perpendicular to the dimension in which the screen is striped.

U.S. Pat. No. 6,393,145 filters the color are filtered in order to generate an oversampled color scan line and filtered again with box filter to generate color values associated with sub-pixel components. Gamma correct ion is applied on the output color.

U.S. Pat. No. 7,342,585 adjusts the number of subpixels to turn on in the direction of emboldening taking into account contractual information regarding surrounding subpixels.

U.S. Pat. No. 7,190,367 uses the progressive cache to determine a cached element most representing a display image satisfying the rendering request.

U.S. Pat. No. 7,129,948 transfers the hints by modifying values in a control value table. The control value table is modified so that they now constrain corresponding control points in the target character.

U.S. Pat. No. 7,095,412 and U.S. Pat. No. 7,095,411 define the hints by one or more statements that contain multiple values that define constraints the glyph.

U.S. Pat. No. 7,068,276, hint is discarded where it appears inappropriate for a character of the second True Type™ font. The system maintains indicant of a discarded hint to indicate where a hint has been discarded.

All the above patents were dealing with data processing and in particular font data processing for mapping text into a conventional RGB image device. Thus RGB subpixel rendered data are embedded in the RGB data stream with determined positions and orders of RGBRGB . . . RGB.

### SUMMARY OF THE INVENTION

The present invention is to provide an image device. The image device includes a plurality of pixel groups. Each pixel group includes a plurality of dots arranged in a predetermined identical matrix form, and each pixel group has at least one first color dot, at least one second color dot, at least one third color dot and at least one fourth color dot. The first color dot and the third color dot are disposed on a first column position of the pixel group, and the second color dot and the fourth color dot are disposed on a second column position of the pixel group. At least one of the first color dot and the third color dot is a green dot, and at least one of the second color dot and the fourth color dot is a red dot.

In a white balance status, the component of green dot has the biggest share of around 60 percent, follow up by red dot with around 30 percent and blue dot with around 10 percent, therefore it is critical to best match the position of green dot and red dot of the conventional RGB data stream, rendered specially to the RGB stripe display, into the 2×2 matrix of AB×CD pixel display where One of the first color dot (A) and the third color dot (C) is a green dot, and one of the second color dot (B) and the fourth color dot (D) is a red dot.

Furthermore, the present invention is to provide a data processing system. The data processing system includes a receiving device and a selecting device. The receiving device is used for receiving a first color data string. The first color data string includes a plurality of first color data group. Each first color data group includes a plurality of first color data. The first color data represents color information in color dots of a first pixel group. The selecting device is used for obtaining a second color data string from the first color data string. The second color data string includes a plurality of second color data group. Each second color data group includes a plurality of second color data. At least one of the second color data represents color information in a neighboring color dot of a neighboring first pixel group next to the first pixel group.

Therefore, the second color data string of the data processing system of the invention can be used to meet the subpixel rendered text quality on non-stripe multi-color displays to get best performance in text quality.

### BRIEF DESCRIPTION OF THE DRAWINGS

Further advantageous measures are described in the dependent claims. The invention is shown in the attached drawings and is described hereinafter in greater detail.

FIG. 1 shows conventional RGB True Type™ data on RGB display;

FIG. 2 shows conventional RGB Clear Type™ data on RGB display;

FIG. 3 shows RGB Clear Type™ data using RGB triplet as input on GR×BW display;

FIG. 4 shows RGB Clear Type™ data using GBR triplet as input on GR×BW display;

FIG. 5 shows the data processing system of the invention;

FIG. 6 shows the first color data string, the second color data and the third color data string of the invention;

FIG. 7 shows a pixel group of the image device according to a first embodiment of the invention;

FIG. 8 shows a pixel group of the image device according to a second embodiment of the invention;

FIG. 9 shows a pixel group of the image device according to a third embodiment of the invention;

FIG. 10 shows a pixel group of the image device according to a fourth embodiment of the invention; and

FIG. 11 shows a pixel group of the image device according to a fifth embodiment of the invention.

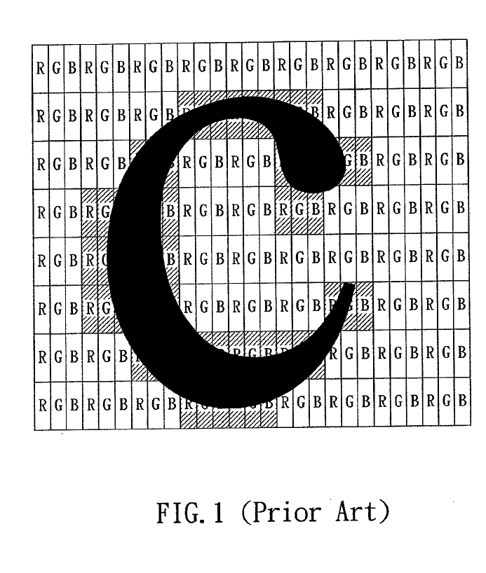

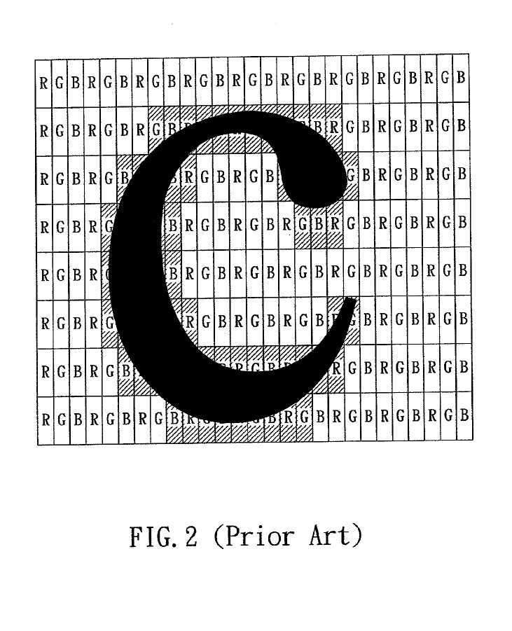

### DETAILED DESCRIPTION OF THE INVENTION

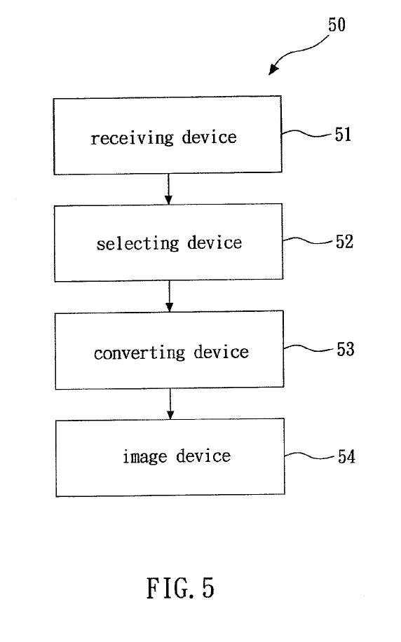

Referring to FIG. 5, it shows the data processing system of the invention. The data processing system 50 of the present invention includes a receiving device 51 and a selecting device 52. The receiving device 51 is used for receiving a first color data string. In the embodiment of the invention, the first color data string is R0G0B0R1G1B1R2G2B2 . . . RnGnBn. The first color data string includes a plurality of first color data groups, for example, the first color data group is R0G0B0, or R1G1B1. Each first color data group includes a plurality of first color data, for example, R0, G0 and B0. The first color data represent color information in color dots of a first pixel group. In the embodiment of the invention, the first color data R0 represents color information in a red color dot of the first pixel group, for example, conventional RGB pixel group; the first color data G0 represents color information in a green color dot of the first pixel group (conventional RGB pixel group); the first color data B0 represents color information in a blue color dot of the first pixel group (conventional RGB pixel group). Therefore, in the embodiment of the invention, the first pixel group includes three color dots, the three color dots are red dot, green dot and blue dot, the first color data represent sequentially color information in the order of red dot, green dot and blue dot of the first pixel group.

The selecting device 52 is used for obtaining a second color data string from the first color data string. In the embodiment of the invention, the second color data string is G0B0R1G1G1R2G2B2 . . . Rn. The second color data string includes a plurality of second color data groups, for example, the second color data group is G0B0R1, or G1G1R2. Each second color data group includes a plurality of second color data, for example, G0, B0 and R1. At least one of the second color data represents color information in a neighboring color dot of a neighboring first pixel group next to the first pixel group. In the embodiment of the invention, the second color data G0 represents color information in a green color dot of the first pixel group (conventional RGB pixel group); the second color data B0 represents color information in a blue color dot of the first pixel group (conventional RGB pixel group); the second color data R1 represents color information in a red color dot of a neighboring first pixel group next to the first pixel group (conventional RGB pixel group). Therefore, in the embodiment of the invention, the second color data represent sequentially color information in the order of green dot and blue dot of the first pixel group and color information in red dot of the neighboring first pixel group.

The second color data string of the data processing system of the invention can be used to meet the subpixel rendered text quality on non-stripe multi color displays. The data processing system 50 further includes a converting device 53 for converting the second color data string to a third color data string. In the embodiment of the invention, the third color data string is r0g0b0w0r1g1b1w1r2g2b2w2 . . . rngnbnwn. The third color data string includes a plurality of third color data groups, for example, the third color data group is r0g0b0w0, or r1g1b1w1. Each third color data group includes a plurality of third color data, for example, r0, g0, b0 and w0. The third color data represent color information in color dots of a second pixel group. In the embodiment of the invention, the third color data TO represents color information in a red color dot of the second pixel group, for example, RGBW pixel group; the third color data g0 represents color information in a green color dot of the second pixel group (RGBW pixel group); the third color data b0 represents color information in a blue color dot of the second pixel group (RGBW pixel group); the third color data w0 represents color information in a white color dot of the second pixel group (RGBW pixel group). Therefore, in the embodiment of the invention, the second pixel group includes four color dots, the four color dots are red dot, green dot, blue dot and white dot.

The data processing system 50 further includes an image device 54 comprising a plurality of second pixel groups for displaying the third color data string.

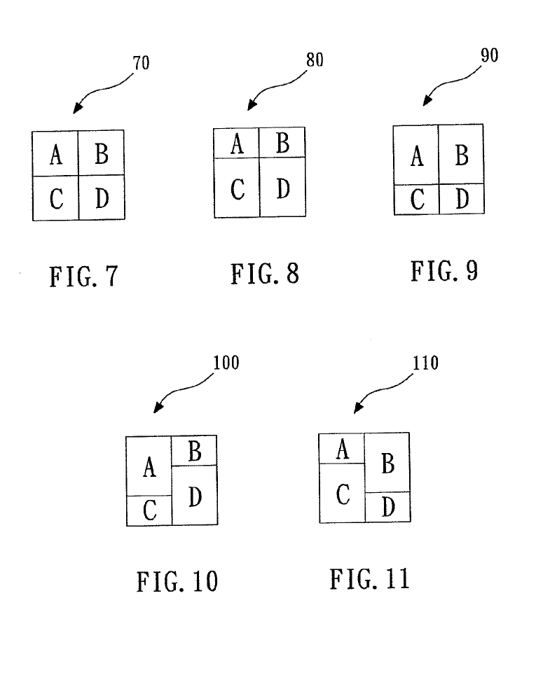

According to the embodiment of the invention, it is assumed that the texts are already rendered by the font engine in the computer system before sending to the display device. The rendered texts into Clear Type™ are then overlaid with the background image to form the RGB frame buffer to be sent from the computer system to the corresponding RGB display. Since the conventional RGB subpixel rendered data such as Clear Type™ font are embedded in the RGB data stream with determined positions and orders of R0G0B0R1G1G1R2G2B2 . . . RnGnBn sent from the computer system to the display, how to map correctly the first color data string into a 2×2 quad pixel display such as a 2×2 matrix RGBW quad pixel display or a 2×2 matrix RGBB quad pixel display is to be determined. From the first color data string R0G0B0R1G1B1R2G2B2 . . . RnGnBn, we know that in a white balance, the component of G has the biggest share of around 60 percent, follow up by R with around 30 percent and B with around 10 percent, therefore it is critical to best match the position of G and R of the first color data string R0G0B0R1G1B1R2G2B2 . . . RnGnBn, rendered specially to the RGB stripe display, into the 2×2 matrix of AB×CD quad pixel display where at least one of A or C has to be Green and at least one of B or D has to be Red as shown in FIG. 7.

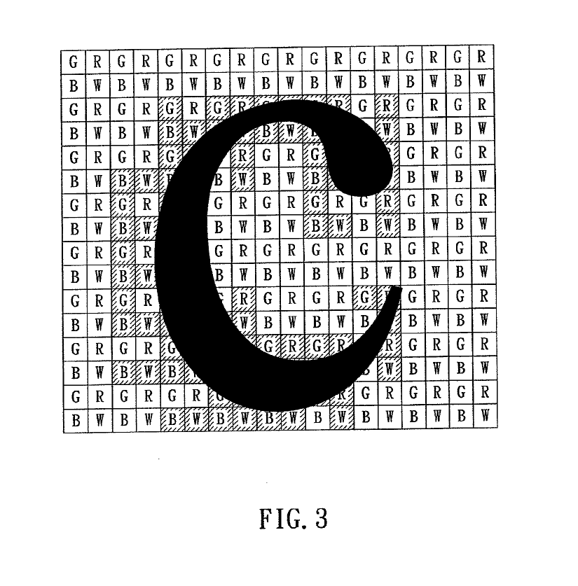

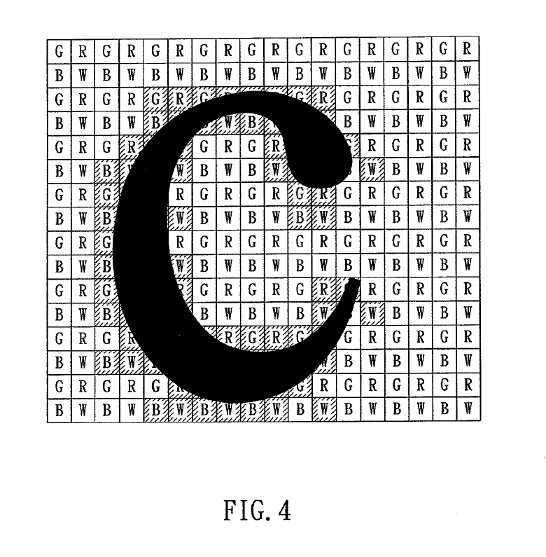

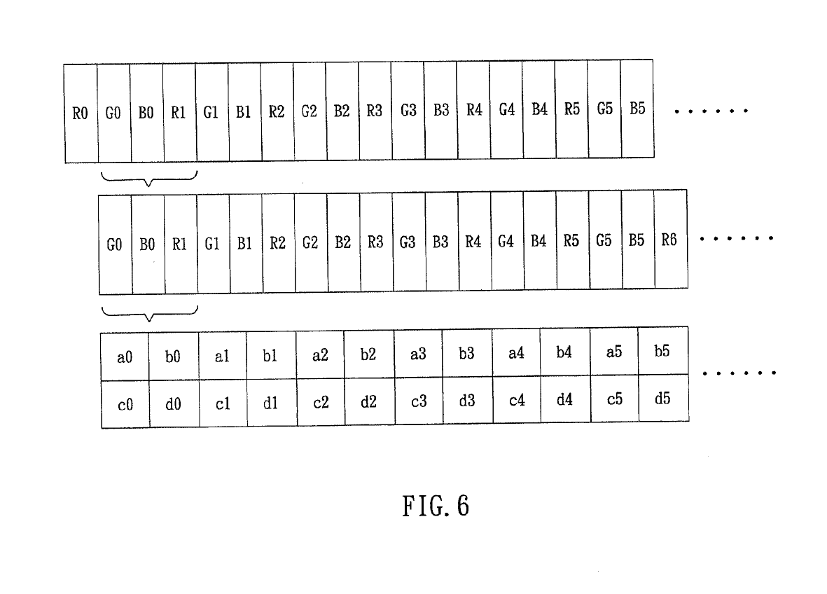

From the first color data string R0G0B0R1G1B1R2G2B2 . . . RnGnBn, we can extract a multiple of 3 triplets of RGB or GBR (by shifting one subpixel) or BRG (by shifting 2 subpixels). Since B component of around 10 percent contribution to white balance carries the least information, the best triplet data to match with the 2×2 quad pixel display has to be the second color data string G0B0R1G1B1R2G2B2 . . . Rn from the first color data string R0G0B0RG1B1R2G2B2 . . . RnGnBn, where the B is in the middle of the triplet data as shown in FIG. 6. With B in the middle of a GBR triplet, G and R surface in a 2×2 matrix quad pixel overlaps the most corresponding same color area of the GBR stripe pixel as shown in FIG. 6. The selecting device 52 of the data processing system 50 of the present invention is to take GBR triplet data from the first color data string R0G0B0R1G1G1R2G2B2 . . . RnGnBn by shifting the first data string of R0G0B0 (as shown in FIG. 6) by one subpixel to obtain the second data group G0B0R1 (as shown in FIG. 6) and to convert the second data group G0B0R1 data into the third data group a0b0×c0d0 of color dots of an innovative AB×CD quad pixel display where at least one of A or C has to be Green and at least one of B or D has to be Red as shown in FIG. 7. For a RGBW display such as GR×BW quad pixel display of U.S. Pat. No. 7,286,136, we map the first GBR data of G0B0R1 into the first GR×BW quad pixel of g0r0×b0w0 by performing a color space conversion from RGB color space to RGBW color space such as per US patent application 20070139669 and we continue with the second triplet data of G1G1R2 and so on. Referring to FIG. 3, it shows RGB Clear Type™ data using RGB triplet as input on GR×BW display, and referring to FIG. 4, it shows RGB Clear Type™ data using GBR triplet as input on GR×BW display. FIG. 4 shows a better image having best performance in text quality than that in FIG. 3.

Referring to FIG. 7, it shows a pixel group of the image device according to a first embodiment of the invention. The image device includes a plurality of pixel groups. Each pixel group 70 includes a plurality of dots arranged in a predetermined identical matrix form, in the first embodiment of the invention, each pixel group 70 includes four quadrate dots arranged in a 2×2 matrix. Each pixel group 70 has at least one first color dot (A), at least one second color dot (B), at least one third color dot (C) and at least one fourth color dot (D). The first color dot (A) and the third color dot (C) are disposed on a first column position of the pixel group 70, and the second color dot (B) and the fourth color dot (D) are disposed on a second column position of the pixel group 70. At least one of the first color dot (A) and the third color dot (C) is a green dot, and at least one of the second color dot (B) and the fourth color dot (D) is a red dot.

In the first embodiment of the invention, the first color dot, the second color dot, the third color dot and the fourth color dot are quadrate shape. In the first type of the first embodiment, the first color dot (A) is a green dot, the second color dot (B) is a white dot, the third color dot (C) is a blue dot and the fourth color dot (D) is a red dot. In the second type of the first embodiment, the first color dot (A) is a green dot, the second color dot (B) is a red dot, the third color dot (C) is a blue dot and the fourth color dot (D) is a white dot. In the third type of the first embodiment, the first color dot (A) is a white dot the second color dot (B) is a red dot, the third color dot (C) is a green dot and the fourth color dot (D) is a blue dot. In the fourth type of the first embodiment, the first color dot (A) is a blue dot, the second color dot (B) is a white dot, the third color dot (C) is a green dot and the fourth color dot (D) is a red dot.

Referring to FIG. 8, it shows a pixel group of the image device according to a second embodiment of the invention. The pixel group 80 includes four dots arranged in a 2×2 matrix. The first color dot (A), the second color dot (B), the third color dot (C) and the fourth color dot (D) are rectangular shape. The area of the first color dot (A) is equal to that of the second color dot (B), the area of the third color dot (C) is equal to that of the fourth color dot (D), the area of the first color dot (A) is smaller than that of the third color dot (C). The sum of the two areas of the two smaller color dots (A) and (B) is equal to the area of one of the bigger color dot (C). In the second embodiment of the invention, the first color dot (A) is a blue dot, the second color dot (B) is a blue dot, the third color dot (C) is a green dot and the fourth color dot (D) is a red dot.

Referring to FIG. 9, it shows a pixel group of the image device according to a third embodiment of the invention. The pixel group 90 includes four dots arranged in a 2×2 matrix. The first color dot (A), the second color dot (B), the third color dot (C) and the fourth color dot (D) are rectangular shape. The area of the first color dot (A) is equal to that of the second color dot (B), the area of the third color dot (C) is equal to that of the fourth color dot (D), the area of the first color dot (A) is bigger than that of the third color dot (C). The sum of the two areas of the two smaller color dots (C) and (D) is equal to the area of one of the bigger color dot (A). In the third embodiment of the invention, the first color dot (A) is a green dot, the second color dot (B) is a red dot, the third color dot (C) is a blue dot and the fourth color dot (D) is a blue dot.

Referring to FIG. 10, it shows a pixel group of the image device according to a fourth embodiment of the invention. The pixel group 100 includes four dots arranged in a 2×2 matrix. The first color dot (A), the second color dot (B), the third color dot (C) and the fourth color dot (D) are rectangular shape. The area of the first color dot (A) is equal to that of the fourth color dot (D), the area of the second color dot (B) is equal to that of the third color dot (C), the area of the first color dot (A) is bigger than that of the third color dot (C). The sum of the two areas of the two smaller color dots (B) and (C) is equal to the area of one of the bigger color dot (A). In the second embodiment of the invention, the first color dot (A) is a green dot, the second color dot (B) is a blue dot, the third color dot (C) is a blue dot and the fourth color dot (D) is a red dot.

Referring to FIG. 11, it shows a pixel group of the image device according to a fifth embodiment of the invention. The pixel group 110 includes four dots arranged in a 2×2 matrix. The first color dot (A), the second color dot (B), the third color dot (C) and the fourth color dot (D) are rectangular shape. The area of the first color dot (A) is equal to that of the fourth color dot (D), the area of the second color dot (B) is equal to that of the third color dot (C), the area of the first color dot (A) is smaller than that of the third color dot (C). The sum of the two areas of the two smaller color dots (A) and (D) is equal to the area of one of the bigger color dot (C). In the second embodiment of the invention, the first color dot (A) is a blue dot, the second color dot (B) is a red dot, the third color dot (C) is a green dot and the fourth color dot (D) is a blue dot.

In a white balance status, the component of green dot has the biggest share of around 60 percent, follow up by red dot with around 30 percent and blue dot with around 10 percent, therefore it is critical to best match the position of green dot and red dot of the conventional RGB data stream, rendered specially to the RGB stripe display, into the 2×2 matrix of AB×CD pixel display where One of the first color dot (A) and the third color dot (C) is a green dot, and one of the second color dot (B) and the fourth color dot (D) is a red dot.

While embodiments of the present invention has been illustrated and described, various modifications and improvements can be made by those skilled in the art. The embodiments of the present invention are therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. A data processing system, comprising:
a receiving device adapted to receive a first color data string, the first color data string comprising a plurality of first color data groups,
each of the first color data groups comprising a plurality of first color data, the first color data representing color information in color dots of multiple first pixel groups; and
a selecting device adapted to obtain a second color data string from the first color data string, the second color data string being adjacent to the first color data string and comprising a plurality of second color data groups,
each of the second color data groups comprising a plurality of second color data,
at least one of the plurality of second color data groups representing color information in each one of the color dots is arranged so as to be adjacent to the color dots of the same colors in each of the first pixel groups.

2. The data processing system according to claim 1, wherein each of the first pixel groups comprises three color dots, the three color dots being a red dot, a green dot, and a blue dot,
wherein the first color data represents sequentially the color information in an order of the red dot, the green dot, and the blue dot of each of the first pixel groups.

3. The data processing system according to claim 2, wherein the second color data represents sequentially the color information in the green dot and the blue dot of the first pixel groups, and the color information in the order of the red dot of the adjacent ones of the first pixel groups.

4. The data processing system according to claim 1, wherein the data processing system further comprises:
a converting device adapted to convert the second color data string to a third color data string,
the third color data string comprising a plurality of third color data groups,
each of the third color data groups comprising a plurality of third color data, the third color data representing the color information in the color dots of multiple second pixel groups.

5. The data processing system according to claim 4, wherein each of the second pixel groups comprises four of the color dots, the four color dots are a red dot, a green dot, a blue dot, and a white dot.

6. The data processing system according to claim 4, wherein the data processing system further comprises an image device comprising a plurality of the second pixel groups for displaying the third color data string.

7. The data processing system according to claim 6,
wherein the image device comprises:
a pixel array consisting of either a plurality of the first pixel groups that are identical to each other arranged directly adjacent to each other, or a plurality of the second pixel groups that are identical to each other arranged directly adjacent to each other,
each of the first pixel groups and the second pixel groups being square-shaped, and consisting of:
four dots arranged in a predetermined identical matrix form, with each of the four dots having an upper side edge, a lower side edge, and two parallel vertical side edges connecting the upper side edge and the lower side edge,
each of the square-shaped pixel groups consisting of one first color dot, one second color dot, one third color dot, and one fourth color dot, each of which is rectangular-shaped,
wherein one of the first color dot and the third color dot is disposed directly above the other in a first column position of the pixel groups, and one of the second color dot and the fourth color dot is disposed directly above the other in a second column position of the pixel groups, and a right side of the first column is directly adjacent to a left side of the second column, and
at least one of the first color dot and the third color dot is a green dot, at least one of the second color dot and the fourth color dot is a red dot,
wherein the four color dots in each of the pixel groups are arranged in a manner such that a horizontal boundary directly between the first and third color dots in the first column position intersects with one of the parallel vertical side edges of one of the second or the fourth color dots in the second column position, at a location away from a horizontal boundary directly between the second color dot and the fourth color dot,
wherein a length of each of the parallel vertical side edges of two of the four color dots in each of the pixel groups is longer than lengths of any one of the upper side edge, the lower side edge, or the parallel vertical side edges of the other two of the four color dots in each of the same pixel groups.

8. The data processing system according to claim 7, wherein the first color dot is a green dot, the second color dot is a blue dot, the third color dot is a blue dot and the fourth color dot is a red dot.

9. The data processing system according to claim 7, wherein the first color dot is a blue dot, the second color dot is a red dot, the third color dot is a green dot and the fourth color dot is a blue dot.

10. The date processing system according to claim 7, wherein the first color dot is a blue dot, the second color dot is a red dot, the third color dot is a green dot and the fourth color dot is a blue dot, and an area of third color dot is equal to a combined area of the first and fourth color dots.

11. The data processing system according to claim 7, wherein the first color dot is a green dot, the second color dot is a blue dot, the third color dot is a blue dot and the fourth color dot is a red dot, and an area of second color dot is equal to a combined area of the second and third color dots.

12. The data processing system according to claim 7, wherein the four color dots in each of the pixel groups are arranged in a manner such that a length of the first color dot is greater than a width of the third color dot.

13. The data processing system according to claim 7, wherein the four color dots in each of the pixel groups are arranged in a manner such that a horizontal boundary directly between the first and third color dots in the first column position intersects with a mid-point of one of the two parallel vertical side edges of one of the second or the fourth color dots in the second column position.

14. The data processing system according to claim 6,
wherein the image device comprises:
a pixel array consisting of either a plurality of the first pixel groups that are identical to each other arranged directly adjacent to each other, or a plurality of the second pixel groups that are identical to each other arranged directly adjacent to each other,
each of the first pixel groups and the second pixel groups being square-shaped, and consisting of:
four rectangular-shaped dots arranged in a predetermined identical 2×2 matrix form, with each of the four dots having an upper side edge, a lower side edge, and two parallel vertical side edges connecting the upper side edge and the lower side edge,
each of the square-shaped pixel groups having one first color dot, one second color dot, one third color dot and one fourth color dot, wherein one of the first color dot and the third color dot is disposed directly above the other in a first column position of each of the pixel groups, and one of the second color dot and the fourth color dot is disposed directly above the other in a second column position of each one of the pixel groups, and an entire right side of the first column is directly adjacent to an entire left side of the second column,
wherein an area of the first color dot is equal to that of the fourth color dot, an area of the second color dot is equal to that of the third color dot, and an area of the first color dot is different from an area of the third color dot, and
in each of the pixel groups, the first color dot in the first column position has one of the parallel vertical side edges directly adjacent to one of the two parallel vertical side edge of the second color dot in the second column position, and each of the parallel vertical side edges of the first color dot has a length that is different from a length of the lower side edge of the first color dot directly adjoining the upper side edge of the third color dot in the first column position,
wherein the length of each of the parallel vertical side edges of two of the four color dots in each of the pixel groups is longer than lengths of any one of the upper side edge, the lower side edge, or the parallel vertical side edges of the other two of the four color dots in the same pixel groups.

15. The data processing system according to claim 14, wherein the first color dot and the second color dot are blue dots, the third color dot is a green dot, and the fourth color dot is a red dot, and each one of the first and second color dots joins one of the vertical side edges of the second color dot at a common point, and
the area of third color dot is equal to a combined area of the first and second color dots.

16. The data processing system according to claim 14, wherein the first color dot is a blue color dot, the second color dot is a blue color dot, the third color dot is a green dot, and the fourth color dot is a red dot, and
each one of the first and the third color dots joins one of the vertical side edges of either the second color dot or the fourth color dot at a common point.

17. The data processing system according to claim 14, wherein the third color dot and the fourth color dot are blue dots, the first color dot is a green dot, and the second color dot is a red dot, and each one of the first and third color dots joins one of the vertical side edges of the fourth color dot at a common point, and
the area of first color dot is equal to a combined area of the third and fourth color dots.

18. The data processing system according to claim 6,
wherein the image device comprises:
a pixel array consisting of either a plurality of the first pixel groups that are identical to each other arranged directly adjacent to each other, or a plurality of the second pixel groups that are identical to each other arranged directly adjacent to each other,
each of the first pixel groups and the second pixel groups being square-shaped, and consisting of:
four dots arranged in a predetermined identical matrix form, with each of the four dots having an upper side edge, a lower side edge, and two parallel vertical side edges connecting the upper side edge and the lower side edge,
each of the square-shaped pixel groups having one first color dot, one second color dot, one third color dot, and one fourth color dot,
wherein one of the first color dot and the third color dot is disposed directly above the other in a first column position of each of the pixel groups, and one of the second color dot and the fourth color dot is disposed directly above the other in a second column position of each of the pixel groups,
an area of the first color dot is different from an area of the third color dot, and
in each of the pixels groups, the first color dot in the first column position has one of the parallel vertical side edges having
a first portion directly adjoining an entire length of one of the parallel vertical side edges of the second color dot in the second column, and
a second portion directly adjoining a portion of the fourth color dot in the second column position, the second portion having a length equal to an entire length of one of the parallel vertical side edges of the second color dot, and
each of the parallel vertical side edges of the first color dot is longer than the lower side edge of the first color dot directly adjoining the upper side edge of the third color dot in the first column position,
wherein the length of each of the parallel vertical side edges of two of the four color dots in each of the pixel groups is longer than lengths of any one of the upper side edge, the lower side edge, or the parallel vertical side edges of the other two of the four color dots in the same pixel groups.

19. The data processing system according to claim 18, wherein the first color dot is the green dot, the second color dot is a blue dot, the third color dot is a blue dot and the fourth color dot is a red dot.

20. The data processing system according to claim 18, wherein the area of the first color dot is equal to an area of the fourth color dot, an area of the second color dot is equal to the area of the third color dot, and the area of the first color dot is bigger than the area of the third color dot.
